(19) United States
(12) Patent Application Publication
(10) Pub. No.: US 2009/0160592 A1
(43) Pub. Date: Jun. 25, 2009

(54) Helical core on-chip power inductor

(76) Inventors: Peter J. Hopper, San Jose, CA (US); Peter Smeys, Mountain View, CA (US); Kyuwoon Hwang, Palo Alto, CA (US); Andrei Papou, San Jose, CA (US)

Correspondence Address: STALLMAN & POLLOCK LLP, P.O. Box 26450, SAN FRANCISCO, CA, 94126, US

(21) Appl. No.: 12/004,384

(22) Filed: Dec. 20, 2007

(51) Int. Cl. H01F 27/02; H01F 41/00

(52) U.S. Cl. 336/83; 29/602.1

(57) ABSTRACT

An on-chip inductor structure includes a conductive inductor coil and a helical ferromagnetic inductor core that is formed to wrap around the conductive coil. The coil is space-apart from the ferromagnetic core by intervening dielectric material. The helical core structure includes at least one magnetic gap lithographically formed in the core.

### FIELD OF THE INVENTION

The present invention relates to semiconductor integrated circuits and, in particular, to techniques for providing a low saturation, helical core power inductor design that includes a magnetic core having a lithographically formed magnetic gap.

### DISCUSSION OF THE RELATED ART

According to Faraday's law, any change in the magnetic environment of a conductive coil will cause a voltage to be “induced” in the coil. No matter how the change is produced, the voltage will be generated. For example, the change could be produced by changing the magnetic field strength, by moving a magnet toward or away from the coil, by moving the coil into or out of the magnetic field, or by changing the amount of current that is flowing through the coil.

In accordance with the well known law of inductance, if a voltage is forced across an inductor, then a time varying current will flow through the inductor. The current flowing in the inductor will be time varying even if the forcing voltage is constant. It is equally true that, if a time varying current is forced to flow in an inductor, then a voltage across the inductor will result.

The fundamental law that defines the relationship between the voltage and current in an inductor is given by the following equation: V=L(di/dt). Thus, current that is constant with time has a (di/dt) value of zero and results in zero voltage across the inductor. A current that is increasing with time has a positive (di/dt) value, resulting in a positive inductor voltage. A current that decreases with time gives a negative value for (di/dt) and, thus, for inductor voltage.

FIGS. 1A-1C combine to show a patterened inductor structure that is disclosed in co-pending and commonly assigned application Ser. No. 11/111,660, filed on Mar. 4, 2005, by Hwang et al. (which application is hereby incorporated by reference herein in its entirety). FIG. 1A shows a top patterned magnetic plate 100 that is subdivided into a plurality of spaced-apart parallel segments 100a. FIG. 1B shows a conductive spiral coil 102. FIG. 1C shows a bottom patterned magnetic plate 104 that is subdivided into a plurality of spaced-apart parallel segments 104a. The coil 102 is separated from the top magnetic plate 100 and from the bottom magnetic plate 104 by intervening dielectric material such as, for example, silicon oxide, silicon nitride, or a spin-on polymer (e.g. cured photoresist, polyimide or BCB). The top magnetic plate 100 and the bottom magnetic plate 104 are preferably a material such as Permalloy (with ratios of 20:80 to 80:20 Ni:Fe), FeCrB, ZrCrTa, CoCr or CoFeNi. The conductive coil is preferably copper.

FIGS. 2A and 2B show cross section views of two magnetic inductor structures that can be used in the parallel segment upper/lower magnetic plate design discussed above. In the FIG. 2A inductor structure 200, in each parallel segment, the patterned top magnetic plate 202 and the patterned bottom magnetic plate 204 surround the inductor coil 206 and touch each other. Large inductance can be made by the FIG. 2A configuration because reluctance is minimized. In the FIG. 2B inductor structure 210, in each parallel segment, there is a finite gap h between the patterned top magnetic plate 212 and the patterned bottom magnetic plate 214 that surround the conductive coil 216. The magnetic path in this configuration is composed of the magnetic layers 212 and 214 and the gap h. The inductance in the FIG. 2B configuration can be adjusted by changing the height h of the gap. Also, magnetic saturation due to high current level can be controlled by the gap height h.

FIG. 3 shows simulated inductance as a function of the gap height h between the top magnetic plate 212 and the bottom magnetic plate 214 of the FIG. 2B inductor structure. As can be seen from the FIG. 3 plot, in the FIG. 2B configuration, inductance increases as the gap height h decreases.

In the FIG. 2B inductor structure, the magnetic gap h, to prevent saturation has been located normal to the thickness of the involved films. More specifically, as shown in FIG. 4A, fabrication of the FIG. 2B structure begins by first forming the layer of ferromagnetic film that comprises the bottom magnetic plate 400, typically utilizing an electroplating process. This is followed by the formation, typically by deposition, of a dielectric layer (e.g., silicon oxide) 402 over the bottom plate 400. The conductive (e.g. copper) inductor coil 404 is then formed and encapsulated in electrically isolating dielectric material (e.g. silicon oxide) 406. Via trenches 408 are then etched in the dielectric material 406 and a further electroplating step is performed to fabricate the top magnetic plate 410. As can be seen from FIG. 4A, the depth of the via trench 408 defines the height h between the top and bottom magnetic plates in the FIG. 2B structure. This via is required to have a tight aspect ratio to minimize both device size and high frequency eddy current losses. The requirement for tight via aspect ratios leads to difficulty in achieving step coverage of the seed layer that is require to be deposited before electroplating of the top plate magnetic material occurs.

FIG. 4B illustrates the problem in greater detail. Due to the high aspect ratio of the via trench 408, the sputtered seed material 412 provides poor step coverage at the bottom of the via trench, with exposed regions 414 of the coil-isolating dielectric material 406 being common. This incomplete seed layer step coverage leads to incomplete and non-uniform electroplating of the ferromagnetic core material 416 and, thus, an ill-defined magnetic gap h, resulting in both poor and variable performance characteristics for the inductor structure.

### SUMMARY OF THE INVENTION

The present invention provides an on-chip inductor structure that includes a conductive inductor coil and a helical ferromagnetic inductor core structure that is formed to wrap around the conductive coil. The ferromagnetic core is space-apart from the inductor coil by intervening dielectric material. The helical core structure has at least one gap formed, preferably lithographically, in a horizontal section thereof. By forming the magnetic gap in a horizontal section of the top plate, the complexity of defining the gap in the processing of the high aspect ratio top plate via is eliminated.

The features and advantages of the various aspects of the present invention will be more fully understood and appreciated upon consideration of the following detailed description of the invention and the accompanying drawings, which set forth an illustrative embodiment in which the concepts of the invention are utilized.

### DESCRIPTION OF THE DRAWINGS

FIGS. 1A-1C are top views illustrating the top patterned magnetic plate, the conductor spiral and the bottom patterned magnetic plate, respectively, of a spiral inductor structure.

FIG. 2A is a cross section view showing the top and bottom magnetic layers of the FIG. 1A-1C spiral inductor structure touching each other.

FIG. 2B is a cross section view showing the top and bottom magnetic layers of the FIG. 1A-1C spiral inductor structure having a finite gap therebetween.

FIG. 3 provides a graph showing simulated inductance as a function of the height of the gap between the top and bottom magnetic plates in the FIG. 2B spiral inductor structure.

FIG. 4A is a cross section view showing a high aspect ration via in an inductor structure with well defined magnetic gaps.

FIG. 4B is a cross section view showing a poorly defined via in an inductor structure as a result of poor seed layer step coverage.

FIG. 5A is a cross section view showing a lithographically defined gap in the horizontal portion of a patterned top magnetic plate in accordance with the concepts of the present invention.

FIG. 5B is a cross section view showing a well defined via that is tolerant to poor step coverage due to underlying metal in accordance with the concepts of the present invention.

### DETAILED DESCRIPTION OF THE INVENTION

The present invention provides a design and technique for fabricating the ferromagnetic core plates of an on-chip inductor structure that does not require that gaps be formed at the bottom of the top plate vias. Elimination of the via gap makes incomplete step coverage of the electroplating seed layer more tolerable because the underlying exposed magnetic material of the lower plate provides for seed continuity. Thus, tighter laminations can be created with electroforming processing.

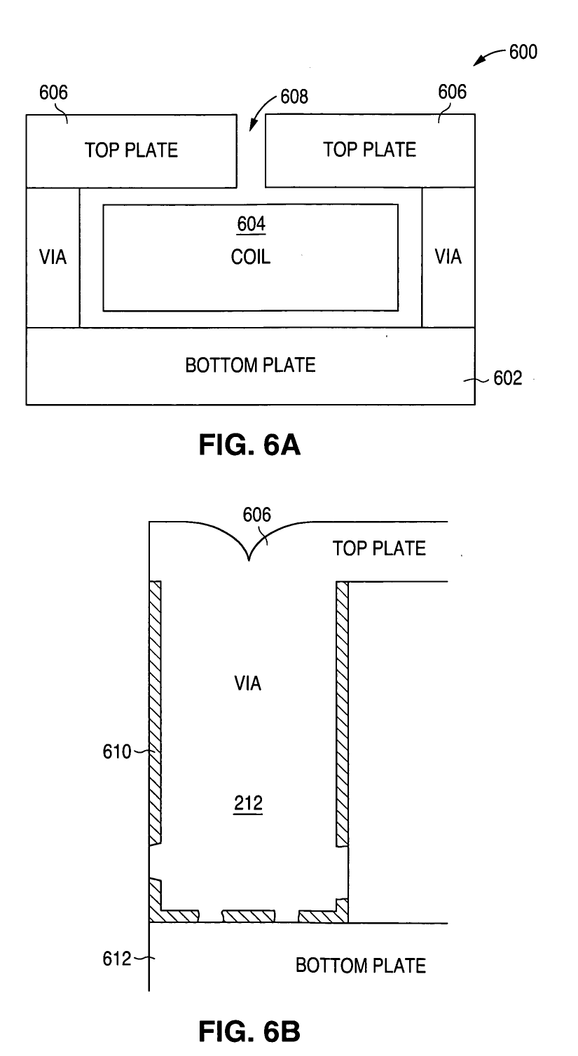

FIGS. 5A and 5B show, respectively, a single helix topology and a double helix topology of an on-chip inductor structure in accordance with the concepts of the present invention. In the FIG. 5A embodiment 500, a single helix ferromagnetic core 502 is formed around the conductive windings of the inductor core 504 in accordance with well known techniques, e.g. electroforming. In accordance with the invention, lithographically defined gap(s) 506 are formed in the single helix ferromagnetic core 502. In the FIG. 5B embodiment 510, a double helix ferromagnetic core 512 is formed around the conductive windings of the inductor core 514 in accordance with well known techniques, e.g. electroforming. In accordance with the invention, lithographically defined gap(s) 516 are formed in each of the two magnetic core helixes.

The helical ferromagnetic inductor core of the FIG. 5A and FIG. 5B structures is preferably a material such as Permalloy (with ratios 20:80 to 80:20 Ni:Fe), FeCrB, ZrCrTa, CoCr or CoFeNi. The conductive inductor core is preferably copper.

As discussed above, the magnetic gap formed in the inductor core, in series with the core's reluctance path, defines the over all reluctance of the core. This reluctance path provides the relationship of magnetic inductance resulting from an applied field. Thus, as an example, by increasing the magnetic gap, the saturation characteristics will flatten out such that a higher over-all applied H-field will be required to saturate the core. Similarly, by placing a longer path of the inductor, for example a helical wrap-around path, around the conductive core, the overall reluctance of the core increases, again, increasing the inductor's saturation field strength required to saturate the core.

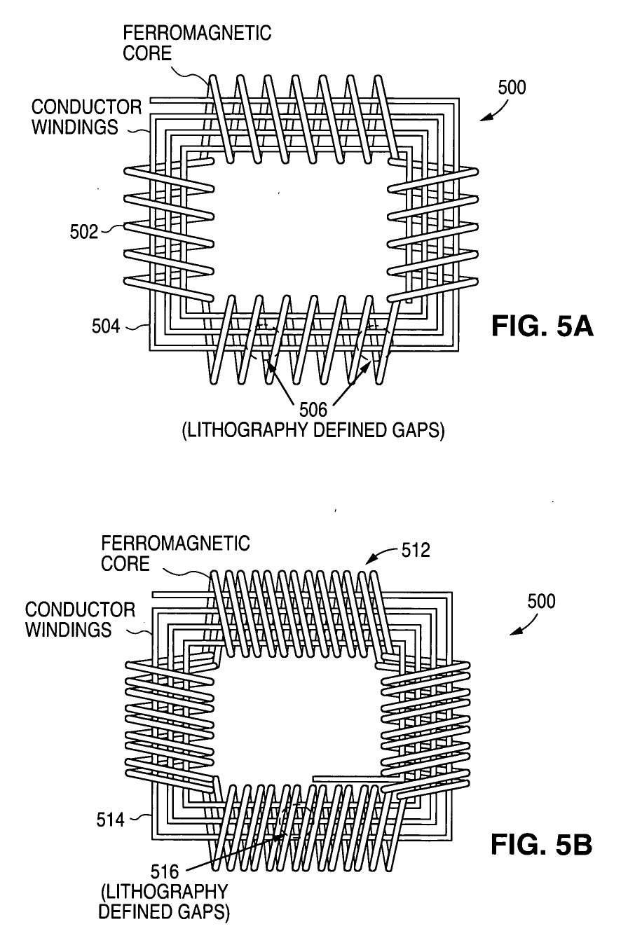

Further, if the magnetic gap can be resolved utilizing convention lithographic techniques with the use of the layout to form the gap (or gaps) in a horizontal section of the core and to define the electroplating mold for the core, the complexity of defining a fixed gap utilizing film processing, as discussed above in conjunction with FIGS. 4A and 4B, and specific to a given process flow is avoided.

As shown in FIG. 6A, the inductor forming techniques of the present invention do not require that the gaps be formed at the bottom of the top plate via and, thus, that the underlying metal be exposed to the electroplating electrolyte. Thus, an incomplete via seed step coverage, as discussed above, is more tolerable because the underlying exposed ferromagnetic bottom plate provides for seed continuity. Thus, tighter laminations can be created with electroforming processing.

More specifically, with reference to FIG. 6A, an on-chip inductor structure 600 in accordance with the invention begins with the formation of the bottom plate 602 of the ferromagnetic core. A conductive coil 604 (e.g. copper) is then formed to be spaced-apart from the bottom plate 502 by intervening dielectric material. The top plate 606 of the ferromagnetic core, including its vias, is then formed to be spaced-apart from the conductive coil by intervening dielectric material and such that the bottom plate 602 and the top plate 606 combine to provide a helical ferromagnetic inductor core that wraps around the conductive coil, as shown for example in FIGS. 5A and 5B. At least one magnetic gap 608, preferably formed utilizing lithographic techniques, is formed in a horizontal section of the top plate 606.

FIG. 6B shows the via structure of the top plate 606 in greater detail. As discussed above, the high aspect ration of the via can lead to incomplete step coverage in the seed layer 610 that facilitates the subsequent electroplating of the ferromagnetic core material 212. In accordance with the invention, since the magnetic gap is formed in the horizontal section of the top plate 606, the seed layer may be deposited directly on the upper surface of the ferromagnetic bottom plate 602 of the magnetic core 600. Thus, the ferromagnetic material of the bottom plate 602 provides seed continuity for top plate electroplating in the regions of discontinuity in the seed layer 610.

Electroforming techniques that are suitable for use in the fabrication of inductor structures in accordance with the present invention are disclosed in co-pending and commonly-assigned U.S. patent application Ser. No. 11/974,143, filed on Oct. 11, 2007, which application is hereby incorporated by reference herein in its entirety. application Ser. No. 11/974,143 discloses that the seed layer can comprise any thin ferromagnetic, high resistance film such as Fe, Ni, Zr, Ta and combinations and compounds thereof (e.g. Ti+Al and NiFe) and that the electroplated ferromagnetic material may be Permalloy.

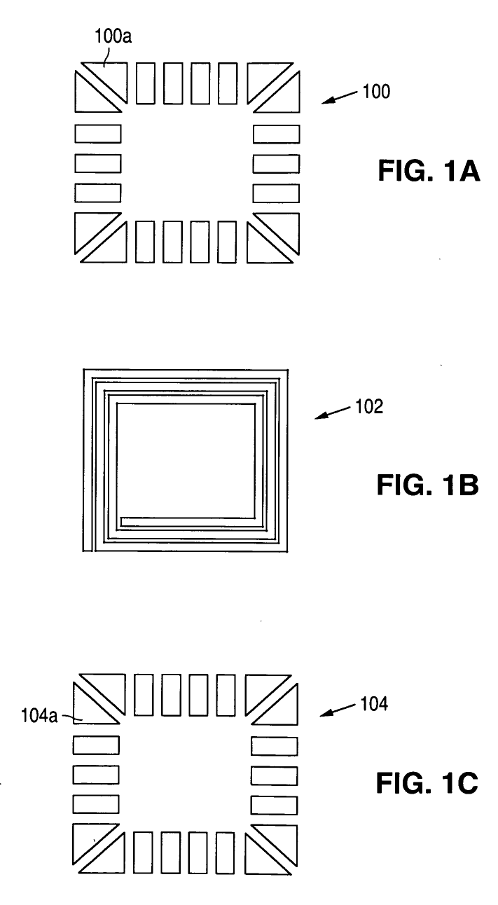

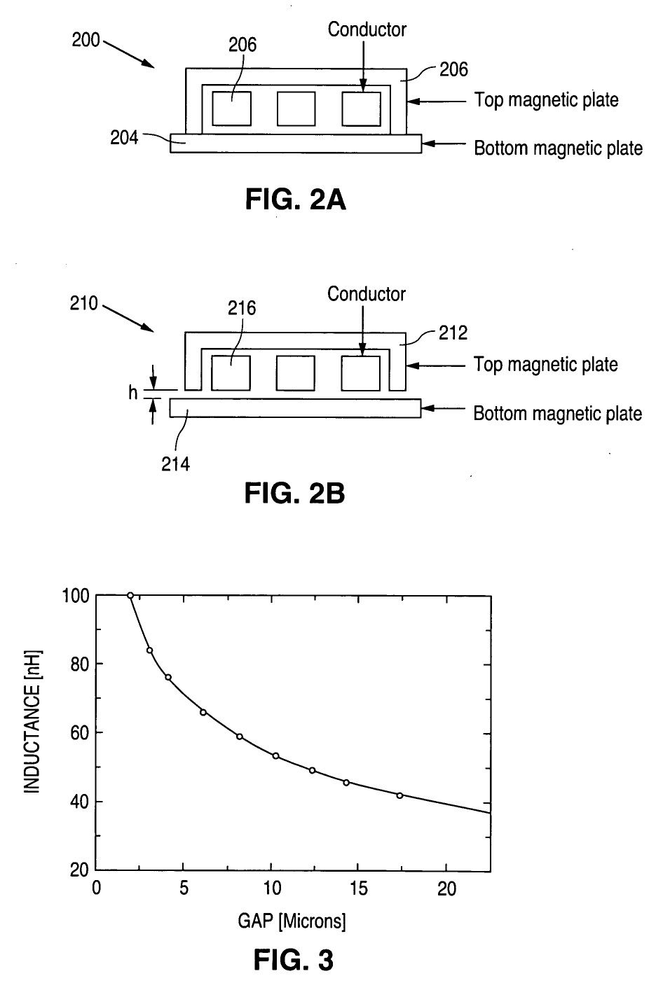

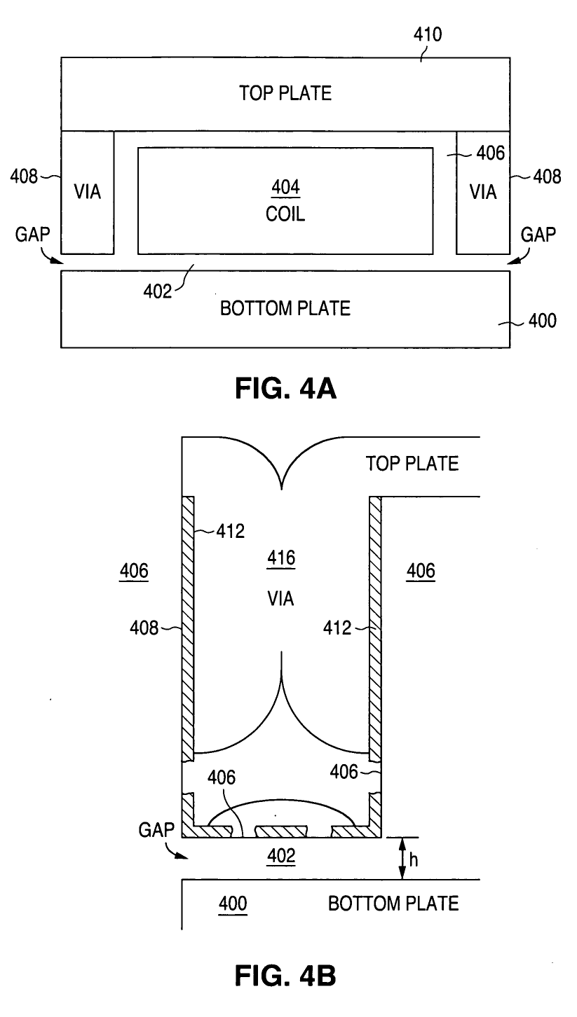

The inductor design of the present invention, which includes a helical magnetic core with lithographically defined gaps, provides improvements over the parallel segment core design discussed above in conjunction with FIGS. 1A-1C, 2A-2B, 3 and 4A-4B. In the case of a series of parallel core elements, and with a gap located exactly twice in the reluctance path of each core segment, there exists little control as to the ratio of gap length to core body length. And, the control is governed by the relatively inflexible “deposited” thickness of the dielectric between the top and bottom core plates. By utilizing a helical core path, without a gap located at the bottom of the core segment vias between the top and bottom ferromagnetic plates, the gap or gaps may be placed lithographically anywhere along the reluctance path of the helical core. The use of a helical core provides a longer continuous reluctance path, equivalent in length to perhaps 30 of the segmented parallel core elements. The gap may, thus, be made larger for a given ration of gap length to core element length. This larger gap may thus be defined lithographically and with cruder tolerances. Similarly, the flexibility of lithographically determined gaps allows for a flexible design approach when considering a spread of core elements and their given saturation sensistivity.

It should be understood that the particular embodiments of the invention described above have been provided by way of example and that other modifications may occur to those skilled in the art without departing from the scope and spirit of the invention as express in the appended claims and their equivalents.

What is claimed is:

1. An on-chip inductor structure comprising:
a conductive inductor coil; and
a helical ferromagnetic inductor core formed to wrap around the conductive inductor coil and spaced-apart therefrom by intervening dielectric material, the helical ferromagnetic inductor core having at least one gap formed therein.

2. An on-chip inductor structure as in claim 1, and wherein the helical ferromagnetic inductor core comprises a single helix magnetic core.

3. An on-chip inductor structure as in claim 1, and herein the helical ferromagnetic inductor core comprises a multiple helix magnetic core structure, each of the multiple helixes having at least one gap formed therein.

4. An on-chip inductor structure as in claim 1, and wherein the helical ferromagnetic core comprises Permalloy.

5. An on-chip inductor structure as in claim 4, and wherein the conductive inductor coil comprises copper.

6. A method of forming an on-chip inductor structure, the method comprising:
forming a bottom plate of a ferromagnetic inductor core;
forming a conductive inductor coil that is space-apart from the bottom plate by intervening dielectric material; and
forming a top plate of the ferromagnetic inductor core that is spaced-apart from the conductive inductor coil by intervening dielectric material and such that the bottom plate and the top plate combine to provide a helical ferromagnetic inductor core that wraps around the conductive inductor coil and has at least one gap formed therein.

7. A method as in claim 6, and wherein the at least one gap is formed utilizing lithography.

8. A method as in claim 6, and wherein the helical ferromagnetic inductor core comprises a single helix magnetic core.

9. A method as in claim 6, and wherein the helical ferromagnetic inductor core comprises a multiple helix magnetic core structure.
